(19) United States
(12) Patent Application Publication
(10) Pub. No.: US 2019/0387435 A1
(43) Pub. Date: Dec. 19, 2019

(54) FLOW CONTROL FOR MULTIBAND AGGREGATION

(71) Applicant: Intel IP Corporation, Santa Clara, CA (US)

(72) Inventors: Laurent Cariou, Portland, OR (US); Yaron Alpert, Hod Hasharon (IL); Bahareh Sadeghi, Portland, OR (US); Robert Stacey, Portland, OR (US)

(21) Appl. No.: 16/480,257

(22) PCT Filed: Dec. 18, 2017
(86) PCT No.: PCT/US17/67124

§ 371 Date: Jul. 23, 2019

Related U.S. Application Data
(60) Provisional application No. 62/451,619, filed on Jan. 27, 2017.

(51) Int. Cl. H04W 28/12; H04W 92/20; H04W 80/02; H04W 88/10

(52) U.S. Cl. CPC H04W 28/12; H04W 88/10; H04W 80/02; H04W 92/20

(57) ABSTRACT

This disclosure describes systems, methods, and devices related to link aggregation between devices. A device may identify multiband capabilities associated with a first device. The device may determine a frequency band of the first device based at least in part on the multiband capabilities. The device may initiate multiband link aggregation on one or more interfaces, wherein a first interface of the one or more interfaces is associated with the frequency band of the first device. The device may cause to establish a connection with a second device using a second interface of the one or more interface.

### CROSS-REFERENCE TO RELATED APPLICATIONS

This application claims the benefit of U.S. Provisional Application No. 62/451,619, filed Jan. 27, 2017, the disclosure of which is incorporated herein by reference as if set forth in full.

### TECHNICAL FIELD

This disclosure generally relates to systems, methods, and devices for wireless communications and, more particularly, flow control for layer 2 (L2) multiband aggregation.

### BACKGROUND

Efficient use of the resources of a wireless local area network (WLAN) is important to provide bandwidth and acceptable response times to the users of the WLAN. However, often there are many devices trying to share the same resources, and some devices may be limited by the communication protocol they use or by their hardware bandwidth.

### BRIEF DESCRIPTION OF THE DRAWINGS

The present disclosure is illustrated by way of example and not limitation in the figures of the accompanying drawings, in which like references indicate similar elements and in which:

FIG. 1 depicts a network diagram illustrating an example network environment of a multiband layer 2 aggregation flow control system, in accordance with one or more example embodiments of the present disclosure.

FIG. 2A depicts an illustrative schematic diagram for a multiband layer 2 aggregation flow control system, in accordance with one or more example embodiments of the present disclosure.

FIG. 2B depicts an illustrative schematic diagram for a multiband layer 2 aggregation flow control system, in accordance with one or more example embodiments of the present disclosure.

FIG. 2C depicts an illustrative schematic diagram for a multiband layer 2 aggregation flow control system, in accordance with one or more example embodiments of the present disclosure.

FIG. 3 depicts an illustrative schematic diagram for a multiband layer 2 aggregation flow control system, in accordance with one or more example embodiments of the present disclosure.

FIG. 4A depicts a flow diagram of an illustrative process for an illustrative multiband layer 2 aggregation flow control system, in accordance with one or more example embodiments of the present disclosure.

FIG. 4B depicts a flow diagram of an illustrative process for an illustrative multiband layer 2 aggregation flow control system, in accordance with one or more example embodiments of the present disclosure.

FIG. 5 illustrates a functional diagram of an example communication station that may be suitable for use as a user device, in accordance with one or more example embodiments of the present disclosure.

FIG. 6 illustrates a block diagram of an example machine upon which any of one or more techniques (e.g., methods) may be performed, in accordance with one or more example embodiments of the present disclosure.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

In the past two decades, the IEEE 802.11 WLAN networks have experienced tremendous growth with the proliferation of Wi-Fi devices, as a major Internet access scheme for mobile computing and electronic devices. Since the early deployment of IEEE 802.11 devices in both enterprise and public networks, there have only been proprietary solutions to provide coordination among access points (APs). However, such coordination is transparent to client devices, meaning that a client device, also called a station (STA), establishes a physical layer connection with only one AP at a time. That is, the STA is able to communicate with only one AP at a time for a particular communication session.

For wave 2 of the current Wi-Fi or for 802.11ax, a very compelling technical improvement can be provided by the definition of link aggregation between different Wi-Fi air interfaces on different bands (800 MHz, 2.4 GHz, 5 GHz, 6 GHz, 28 GHz, 45 GHz, 60 GHz, and others). Simultaneous dual band operation (e.g., 2.4 and 5 GHz) is common in APs on the market today and tri-band devices (e.g., 2.4, 5 GHz and, 60 GHz and/or 5 GHz High and 5 GHz low bands are at early penetration stage. layer 2 Link aggregation may be applicable to multiple air interfaces in the same band (e.g., to independent 802.11ac/ax air interfaces at 5 GHz on two different operating BWs channels). It should be understood that layer 2 refers to the Data Link layer of the open systems interconnection (OSI).

Example embodiments described herein provide certain systems, methods, and devices, for enhancing the performance of wireless devices using link aggregation between multiple access points in various wireless networks, including, but not limited to, IEEE 802.11ax, IEEE 802.11ay, or wireless based on 5G 3GPP technologies.

In one embodiment, a multiband layer 2 aggregation flow control system may provide a means by which significantly higher throughput or higher reliability may be achieved if two STAs, or an STA and an AP, support simultaneous multiband operation. Throughput is defined as bits per second. It should be noted that the aggregation is done using L2 signaling and L2 packets

In one embodiment, a multiband aggregation layer 2 flow control system may include one or more APs that may be controlled by a controller device in order to effectuate collaboration between the APs. In this scenario, some APs may support different frequency bands (e.g., 2.4 GHz, 5 GHz, 6 GHz, etc.). For example, in a deployment scenario, a main AP (also referred to as an anchor AP) may cover a large area with long range (e.g., 800 MHz, 2.4 GHz, 5 GHz, 6 GHz, etc.), and one or more other APs (also referred to as booster APs), which may cover a small area with short range (e.g.,28 GHz, 45 GHz, 60 GHz, etc.) with more capacity and throughput, but with smaller distance range. Within the coverage area of the anchor AP, the coverage area may also cover the one or more booster APs.

In one embodiment, a multiband aggregation layer 2 flow control system may define a multiband proxy. The multiband proxy may be a proxy device in the network that receives and aggregates packets coming in the downlink or the uplink traffic directions. For example in the downlink scenario, the packets may be coming from the upper layers (or the internet), where the multiband proxy makes decisions on whether to forward the received packets to a first AP or a second AP, where the packets would then be transmitted to an STA.

In one embodiment, a multiband aggregation layer 2 flow control system may facilitate that as the packets arrive at the multiband proxy, they are stored in a buffer, where each packet will be assigned a sequence number. The packets that have been assigned multiband sequence numbers may then be transmitted to the first AP or the second AP. A multiband sequence number may be a multiband common packet identifier, a multiband traffic stream identifier or a multiband flow identifier, which is meant as an identifier associated with a packet.

In one embodiment, a multiband aggregation layer 2 flow control system may define a link aggregation at a media access control (MAC) layer (or higher layers), by establishing multiple links between two peer STAs on different bands with different air interfaces, which operate independently from the each other. These multiple links may be aggregated, for instance, in a multiband common MAC defined in each of the peer STAs. Fast session transfer (FST) defined in 802.11ad may serve as a baseline framework for this link aggregation.

In one embodiment, the aggregation may enable a traffic flow to be distributed on multiple bands/air interfaces in order to sum the throughputs from the different air interfaces. The aggregation may also direct a specific traffic type on the best air interface (highest throughput interface, most reliable interface, or lower latency interface, readability information (e.g., packet error ratio (PER), etc.). This aggregation may be done transparently to the upper layers, in which case a single MAC service access point (SAP) is exposed to the upper layers. It should be understood that PER may be the number of error packets after forward error correction (FEC) divided by the total number of received packets.

In one embodiment, a multiband aggregation flow control system may determine to split the MAC layer functionality of a device (e.g., an AP) into two parts. The two parts may be an common MAC layer and a dedicated MAC layer. Consequently, the common MAC layer may be on a different device or on the same device. For example, the common MAC layer of an AP may be located in a multiband proxy device, while the dedicated MAC layer of the AP may continue to be on the AP. The common MAC layer and the dedicated MAC layer may be collocated. In the case where the common MAC layer and the dedicated MAC layer are collocated, the common MAC layer would forward the packets as they come to the dedicated MAC layer when the data is traveling in the downlink direction, while the dedicated MAC layer would forward the packets as they come to the common MAC layer when the data is traveling in the uplink direction. The common MAC layer would be responsible for multiband sequence number assignment, buffering, packet reordering, and traffic steering. The dedicated MAC layer would be responsible for transmitting packets received from the common MAC layer (in the downlink direction) to the PHY layer for transmission to the STA.

In one embodiment, a multiband aggregation layer 2 flow control system may perform flow control using a traffic steering function or the flow control function included in the common MAC layer. The traffic steering function on the multiband proxy may determine how to “on the fly” split the traffic between the interfaces. Once the packets arrive and are stored in the buffer and/or need to retransmit, the traffic steering device determines whether to send a first portion of packets to a first AP and another portion of packets to a second AP. The traffic steering device needs to know the network conditions associated with the first AP and the second AP before it makes the determination to send the packets. For example, the traffic steering function may determine that one interface may be capable of handling more packets than another interface. In effect, the traffic steering function may load balance the allocation of the packets to be transmitted on the interfaces. One or more factors may impact how the traffic steering function selects a certain number of packets to be transmitted on a first interface and another number of packets to be transmitted on a second interface. The first interface and the second interface may be in the same frequency band, where the first interface is an upper portion of the frequency band and the second interface is a lower portion of the frequency band. For example, some of these factors may include throughput determination or latency determination on the interfaces and/or reliability on the interfaces (e.g., packet error ratio (PER). This information may be provided by the APs to the multiband proxy device. In case the multiband proxy device is within one of the APs, the throughput determination and latency determination may be provided by the dedicated MAC layer to the common MAC layer, where the traffic steering resides. It should be understood that throughput is the rate of successful packet delivery over a communication channel The latency may be determined by measuring a time delay from one networked point to another. Latency is measured by sending a packet that is returned to the transmitting device, where the round-trip time is considered the latency.

In one embodiment, a multiband aggregation layer 2 flow control system may be implemented on an STA such that the STA will contain two or more interfaces associated with two or more frequency bands. For example, an STA may have one interface to communicate on 5 GHz and another interface to communicate on 6 GHz. The two or more interfaces would work together in order to aggregate all packets received on the two or more interfaces associated with the two or more frequency bands in the downlink direction, where the packets are received from one or more APs. In the reverse direction (e.g., uplink direction), the STA would split the packets that are generated for the uplink transmission to be transmitted on the two or more interfaces. For example, a portion of the packets may be sent on a first frequency band (e.g., 2.4 GHz, 5 GHz, 6 GHz, 60 GHz, etc.) and another portion of the packets may be sent on a second frequency band (e.g., 2.4 GHz, 5 GHz, 6 GHz, 60 GHz, etc.). The first interface and the second interface may be in the same frequency band, where the first interface is an upper portion of the frequency band and the second interface is a lower portion of the frequency band. A multiband sequence number may be assigned to each of the packets such that devices receiving these packets from separate interfaces are capable of reorganizing or reordering the packets in the original order sequentially. It should be understood that the multiband sequence number is not necessarily associated with the frequency band interface where the packet was sent from or to. Packets may be received and stored in a buffer until all the necessary packets are received and buffered. Then the packets are reordered based on the multiband sequence number for correct decoding (e.g., ordering from first packet to last packet).

In one embodiment, a multiband aggregation layer 2 flow control system may facilitate that when an STA is connected to, for example, a first AP (e.g., an anchor or booster AP) and a second AP (e.g., an anchor or booster AP), the STA may be able to aggregate the throughput, such that the STA is capable of sending some traffic on a first operating frequency band through the first AP and sending some traffic on, a second operating frequency band through the second AP. This is true in the uplink direction (e.g., from the STA to the APs) and in the downlink direction (e.g., from the APs to the STA). That is, in the downlink and the uplink, the traffic will be split between the two air interfaces (e.g., the first operating frequency band and the second operating frequency band). For example, if the throughput is 100 megabits per second on the first AP and 200 megabits per second on the second AP, a 300 megabits per second aggregated throughput may be achieved.

The above descriptions are for purposes of illustration and are not meant to be limiting. Numerous other examples, configurations, processes, etc., may exist, some of which are described in detail below. Example embodiments will now be described with reference to the accompanying figures.

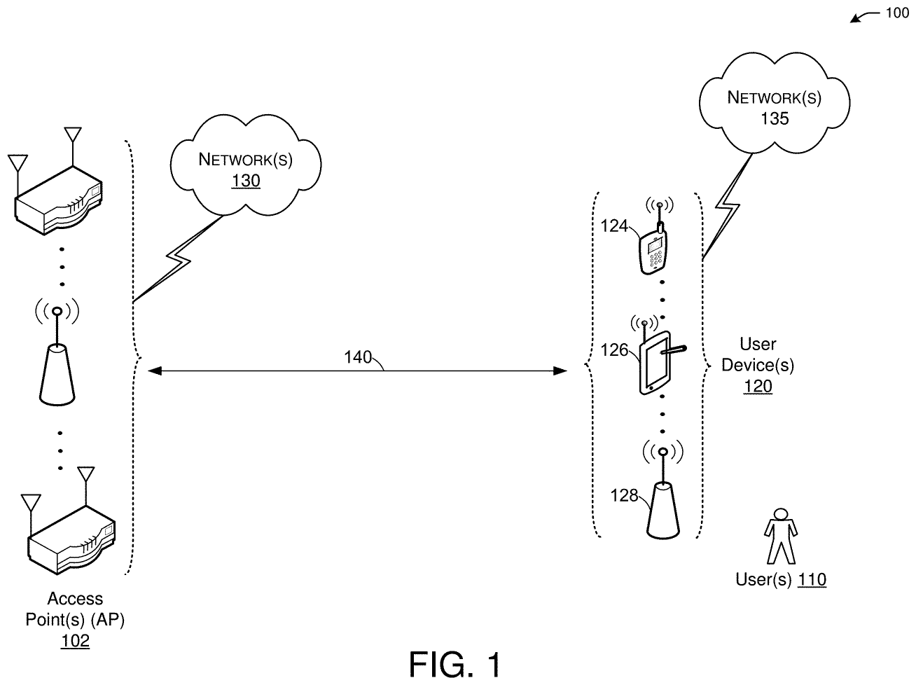

FIG. 1 is a network diagram illustrating an example network environment of multiband aggregation flow control system, according to some example embodiments of the present disclosure. Wireless network 100 may include one or more user devices 120 and one or more responding device(s) (e.g., AP(s) 102), which may communicate in accordance with IEEE 802.11 communication standards. The user device(s) 120 may be mobile devices that are non-stationary (e.g., not having fixed locations) or may be stationary devices.

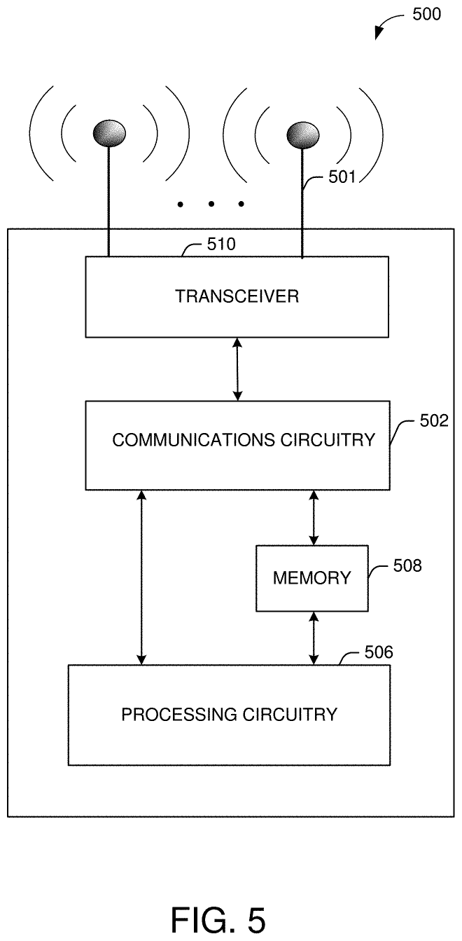

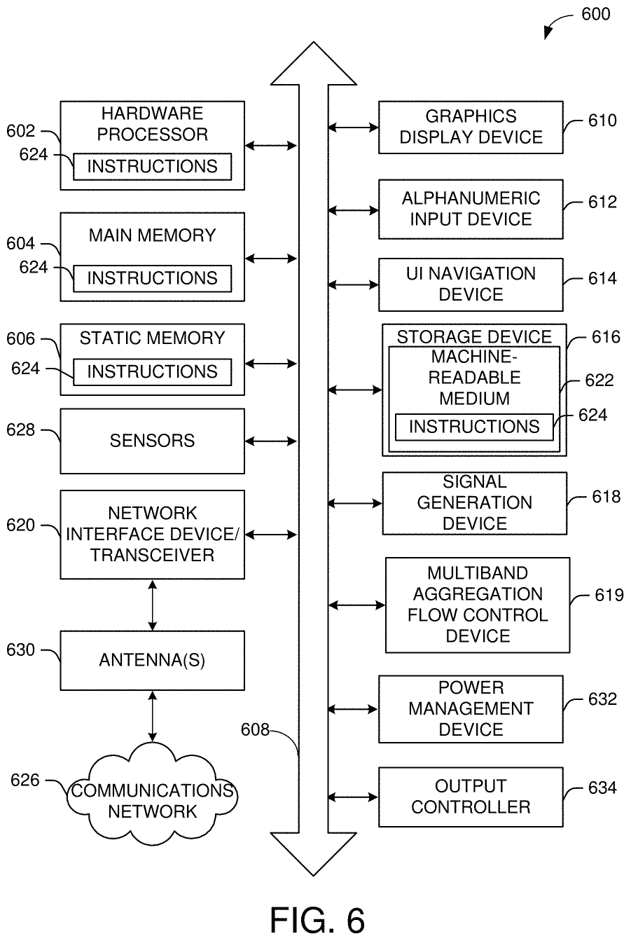

In some embodiments, the user devices 120 and the AP(s) 102 may include one or more computer systems similar to that of the functional diagram of FIG. 5 and/or the example machine/system of FIG. 6.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static, device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

When one or more APs (e.g., AP(s) 102) establish communication 140 with one or more user devices 120 (e.g., user devices 124, 126, and/or 128), the AP(s) 102 may communicate in a downlink direction and the user devices 120 may communicate with one or more AP(s) 102 in an uplink direction by sending data frames in either direction. The user devices 120 may also communicate peer-to-peer or directly with each other with or without the AP 102.

It is understood that the above descriptions are for purposes of illustration and are not meant to be limiting.

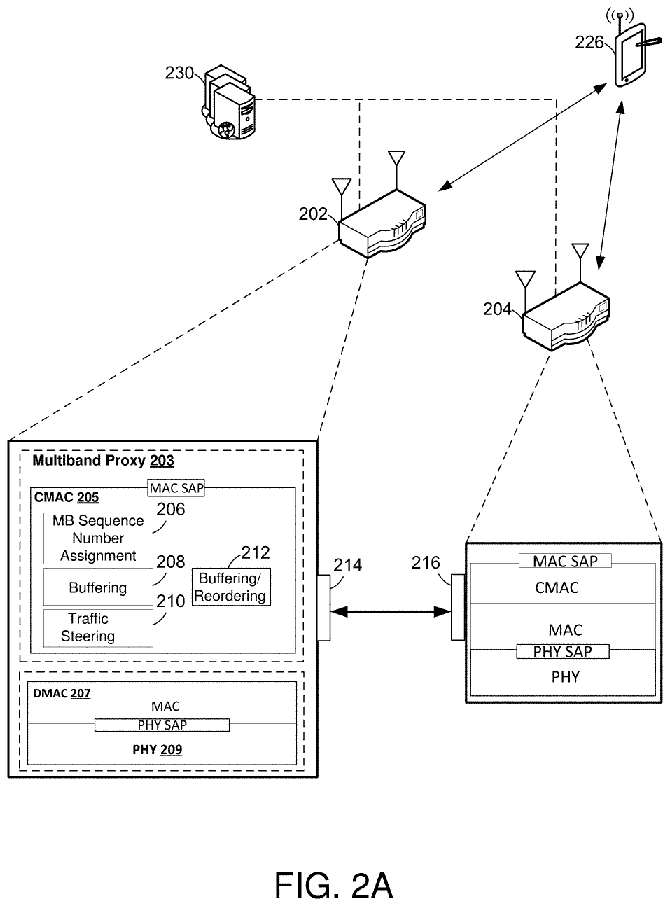

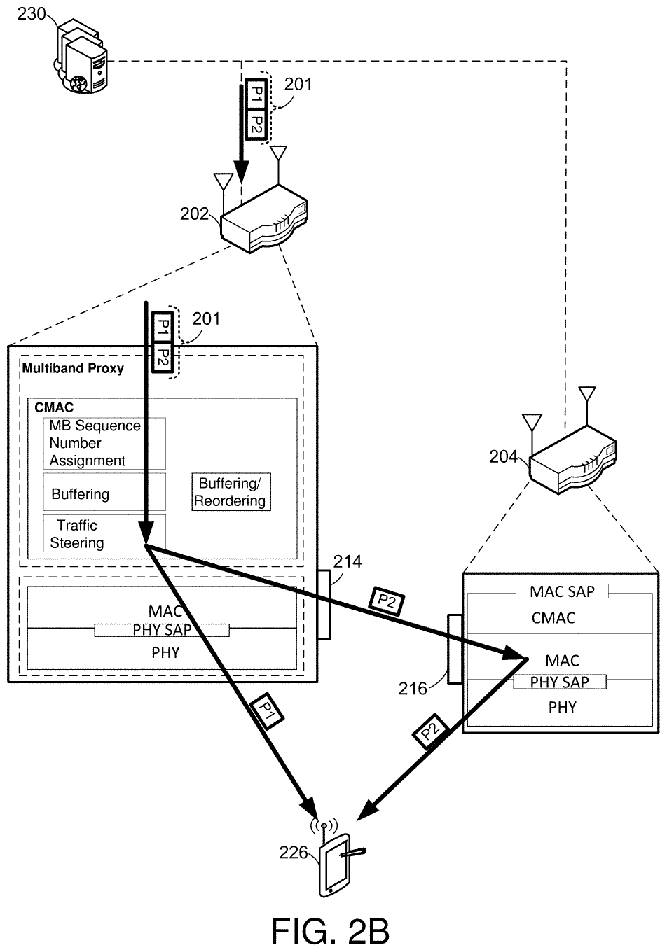

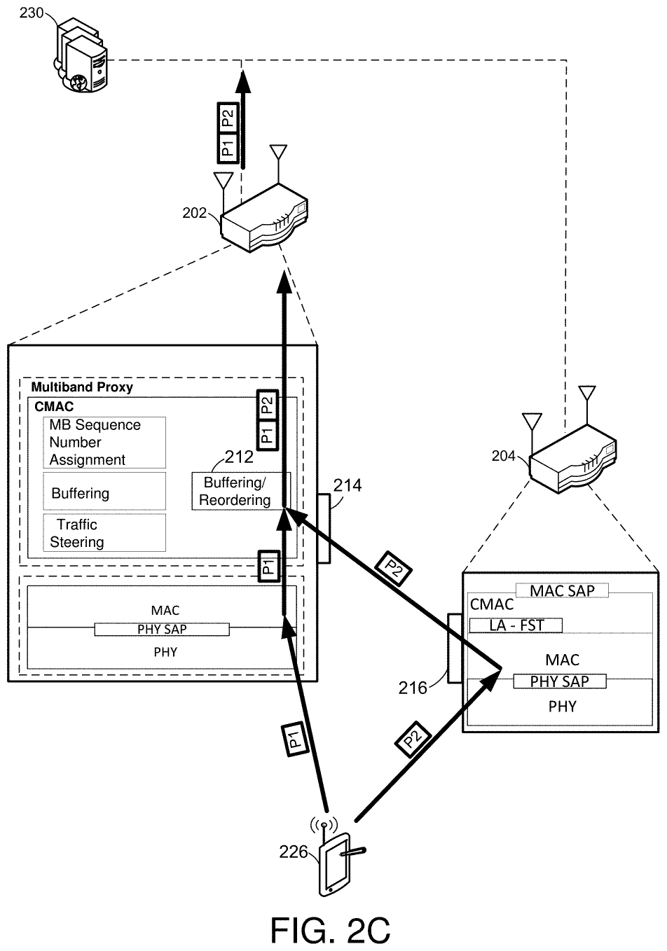

FIG. 2A depicts an illustrative schematic diagram 200 for a multiband aggregation flow control system, in accordance with one or more example embodiments of the present disclosure.

Referring to FIG. 2A, there is shown a user device 226 communicating with two APs (e.g., AP 202 and AP 204) in one communication session (e.g., a video streaming traffic stream). For example, the user device 226 may be accessing a web page on the internet and the AP 202 and AP 204 may be servicing the user device 226 to complete its request to access the web page. In essence, the AP 202 and the AP 204 are both collaborating to service the user device 226. The AP 202 and the AP 204 may be managed by a control device 230. However, the control device 230 may not be necessary. In some embodiments, the AP 202 and the AP 204 may designate one of them to be a device capable of managing traffic between them and the user device 226 instead of using a control device 230.

In this example, the AP 202 is designated to utilize a multiband proxy device (e.g., multiband proxy 203), which is responsible for performing multiband L2 aggregation flow control and traffic steering (e.g., directing, routing). The multiband proxy 203 may receive and aggregates packets coming in the downlink or the uplink traffic directions. For example in the downlink scenario, the packets may be coming from the upper layers (or the internet or the controller device 230), where the multiband proxy 203 makes decisions as to whether to forward the received packets to the dedicated MAC 207 of the AP 202 or to the AP 204 through the air interface 214, where the packets would then be transmitted to air interface 216. The packets would then be transmitted to the user device 226. The AP 204 may include an common MAC layer and a dedicated MAC layer but may not be designated as a multiband proxy device. Therefore, the AP 204 may process the packets internally to be transmitted to the user device 226 without having to assign any multiband sequence numbers, or perform traffic stream steering or reordering of the packets. However, should be understood that although the AP 204 is shown without a multiband proxy, the AP 204 may still include a multiband proxy with similar functionalities as the multiband proxy 203 and have a multiband sequence number assignment function, a buffering function, and a traffic steering function in a buffering/reordering function. The AP 204 may not use those functionalities if it is not designated as the multiband proxy.

The MAC layer of the AP 202 may be divided into two MAC layers, the common MAC (CMAC) 205, and the dedicated MAC (DMAC) 207. Although in FIG. 2, the multiband proxy 203 is shown to be part of the AP 202, the multiband proxy 203 (including the common MAC layer) may be on a different device or on the same device. In the case where the common MAC 205 and the dedicated MAC 207 are collocated, the common MAC 205 would forward the packets as they come to the dedicated MAC 207 when the data is traveling in the downlink direction, while the dedicated MAC 207 would forward the packets as they come to the common MAC 205 when the data is traveling in the uplink direction. The common MAC 205 may be responsible for multiband sequence number assignment, buffering, packet reordering, and traffic steering. The dedicated MAC 207 may be responsible for transmitting packets received from the common MAC 205 (in the downlink direction) to the PHY layer (e.g., PHY 209). The PHY 209 would then send the packets to the user device 226. When the packets are received at the user device 226, they may be received from AP 202 and/or AP 204.

The user device 226 may have one or more interfaces to handle packets received from AP 202 and/or AP 204. For example, the user device 226 may have one or more interfaces to handle traffic coming from the various APs. For example, the user device 226 may include one interface to communicate on 5 GHz (e.g., or any other frequency band) and another interface to communicate on 6 GHz (e.g., or any other frequency band). The two or more interfaces would work together in order to aggregate all packets received on the two or more interfaces associated with the two or more frequency bands in the downlink direction, where the packets are received from AP 202 and AP 204. In the reverse direction (e.g., uplink direction), the user device 226 may split the packets that are generated for the uplink transmission to be transmitted using the two or more interfaces. For example, a portion of the packets may be sent on a first frequency band (e.g., 2.4 GHz, 5 GHz, 6 GHz, 60 GHz, etc.) towards AP 202, and another portion of the packets may be sent on a second frequency band (e.g., 2.4 GHz, 5 GHz, 6 GHz, 60 GHz, etc.) towards AP 204.

Referring to FIG. 2A, a link aggregation of non-collocated air interfaces is shown, where the multiband proxy may be collocated with AP 202 (referred to as anchor AP), and two links can be aggregated, one with the AP 202, and one with AP 204, referred to as booster AP. The links between the user device 226 and the two APs may be aggregated.

In one embodiment, link aggregation of non-collocated air interfaces operating independently may be enabled between two peer STAs. A multiband upper-MAC layer may be defined on both sides, for example, on the client side and on the infrastructure (AP) side. On the infrastructure side, this multiband upper-layer, also known as a multiband proxy, may be non-collocated or collocated with one or multiple APs.

The AP 202 (or AP 204) that is being designated to contain the multiband proxy 203, may perform one or more operations associated with aggregating and splitting packets between various entities. For example, in the common MAC 205 on AP 202, there may be a multiband sequence number assignment function 206, a buffering function 208, a traffic steering function 210, and a buffering/reordering function 212.

The multiband sequence number assignment function 206 may facilitate allocation and assignment of multiband sequence numbers. A multiband sequence number may be assigned to each of the packets such that device receiving these packets from separate interfaces is capable of reorganizing or reordering the packets in the original order (e.g., how the packets were placed in the sequence of packets in the original order). It should be understood that the multiband sequence number is not necessarily associated with the frequency band interface where the packet was sent from or to. Packets may be received and stored in a buffer until all the necessary packets are received and buffered.

The buffering function 208 may facilitate that as the packets arrive at the multiband proxy 203, they are stored in a buffer or a memory location, where each packet will be assigned a sequence number. The packets having been assigned multiband sequence numbers may then be transmitted to the AP 202 or the AP 204.

The traffic steering function 210 may determine how to split the traffic between the interfaces. Once the packets arrive and are stored in the buffer, the traffic steering function 210 may determine whether to send a first portion of packets to a AP 202 and another portion of packets to AP 204. The traffic steering function 210 may need to know the network conditions associated with AP 202 and AP 204 before it makes the determination to send the packets. For example, the traffic steering function 210 may determine that one interface (e.g., air interfaces 214 or 216) is capable of handling more packets than another interface. In effect, the traffic steering function may load balance the allocation of the packets to be transmitted on the interfaces. One or more factors may impact how the traffic steering function selects a certain number of packets to be transmitted on a first interface and another number of packets to be transmitted on a second interface. The first interface and the second interface may be in the same frequency band, where the first interface is an upper portion of the frequency band and the second interface is a lower portion of the frequency band. For example, some of these factors may include throughput determination or latency determination on the interfaces. This information may be provided by the APs to the multiband proxy device. In the case where the multiband proxy device is within one of the APs, the throughput determination and latency determination may be provided by the dedicated MAC layer to the common MAC layer, where the traffic steering resides. It should be understood that throughput is the rate of successful packet delivery over a communication channel The latency may be determined by measuring a time delay from one networked point to another. Latency is measured by sending a packet that is returned to the transmitting device, where the round-trip time is considered the latency.

The buffering/reordering function 212 may receive various packets from either the dedicated MAC 207 or the AP 204. The buffering/reordering function 212 would place these incoming packets into a buffer or a memory device. The stored packets would then be reorganized or otherwise reordered using the buffering/reordering function 212.

In one embodiment, a multiband aggregation flow control system may facilitate a feedback mechanism from the different APs to the multiband proxy used in guiding flow control decisions. For example, a first feedback mechanism solution may rely on feeding back throughput and latency estimates of the link between the STA and the AP. Based on this information, the multiband proxy may compare the metrics from all bands and use these metrics to perform multiband flow control. This, however, does not enable lossless transitions.

A second solution may rely on feeding back a report to the multiband proxy, every time a packet or a group of packets has been successfully delivered to the peer STA. This report may include the multiband sequence numbers of the packets transmitted (or the first and last sequence number of a group of packets), the time at which they were delivered and possibly other information. Based on that information, the multiband proxy may derive per-band throughput and latency metrics to guide multiband flow control decisions. In addition, the multiband proxy can free up memory by removing from its buffers all the packets that have been transmitted. The remaining packets (for which the multiband proxy did not receive a report that they had been successfully transmitted) may then be steered to another band/air interface/AP. This re-steering decision may be taken for instance after a specific timeout for each packet or group of packets. This allows for lossless transitions of traffic between bands.

In one embodiment, a multiband aggregation flow control system may facilitate multiband flow control decisions with lossless data flow transitions between bands that adapts to varying throughput and latency on each band air interface. It is understood that the above descriptions are for purposes of illustration and are not meant to be limiting.

In one embodiment, an AP may send a report to the multiband proxy when a packet or a group/block of packets has been successfully received.

This report may include, at least in part, the multiband sequence number of the packets or from the block of packets, and the time at which they were delivered (for each packet or for the block of packets). It should be noted that this information may be implicitly carried in the report if the report is sent following a specific trigger, such as the effective delivery of a packet on the AP side. If the reports are not sent following delivery of a packet and are scheduled at specific time intervals, based on an agreement between the AP and the multiband proxy, then such information should be explicitly included. Alternatively, and/or optionally, the report may include information relating to:

Whether the retries have been transmitted before successful reception of the packet; a determination of the rate used for the packet transmission, and/or the RSSI of the link; and/or an estimation of the channel load.

In one embodiment, based on all the reports received, the multiband proxy progressively may adapt multiband flow control decisions progressively. If no clear per band link throughput and latency are known when the link aggregation is established, the multiband flow control decisions may be made sub-optimally. However, as reports are regularly fed back, the multiband flow control decisions may become more and more accurate and converge toward optimal performance If accurate per band link throughput and latency are available during the initiation phase, then performance also may be improved during the establishment phase.

The multiband flow control decision may also adapt to variation in the link conditions between the AP and the STAs on each band, based on the reports from each AP. The speed of adaptation depends on how reactive the multiband flow control algorithm is designed.

A very simple implementation of such an algorithm may be done by defining a multiband flow control timeout value for each packet or group of packets. These timeout values may be different for different multiband data flows (which can be for instance a traffic flow for a specific class of service, often called a data bearer in the cellular domain) This timeout is triggered when the packets arriving from the upper layers are steered to a specific band/AP (the steered packets are buffered in the meantime in the multiband proxy). If a report ensuring successful transmission is not received before this timeout expires for this packet or group of packets, these buffered packets may be redirected to another AP/air interface. If the packets are received, the timeout is cancelled and the related packets may be removed from the buffers in the multiband proxy.

In one embodiment, if the multiband proxy decides on a traffic steering transition between an old and a new band/AP, while data transmission is ongoing, the fact that packets (that still have not been received successfully) are buffered in the multiband proxy may enable a lossless transition. When the transition is decided by the multiband proxy: 1) the incoming packets will be steered to the new band/AP; and 2) the packets in the buffers that still have not been successfully received on the old AP/band can also be steered to the new band/AP to ensure that these packets will not be lost. It is understood that the above descriptions are for purposes of illustration and are not meant to be limiting.

FIG. 2B depicts an illustrative schematic diagram for multiband aggregation flow control system, in accordance with one or more example embodiments of the present disclosure.

Referring to FIG. 2B, there is shown a user device 226 communicating with two APs (e.g., AP 202 and AP 204) in one communication session (e.g., a video streaming session). For example, the user device 226 may be accessing a web page on the internet, and the AP 202 and the AP 204 may be servicing the user device 226 to complete its request to access the web page. In essence, the AP 202 and the AP 204 are both collaborating to service the user device 226. The AP 202 and the AP 204 may be managed by a control device 230. However, the control device 230 may not be necessary. In some embodiments, the AP 202 and the AP 204 may designate one of them to be a device capable of managing traffic between them and the user device 226 instead of using a control device 230.

In this example, packets 201 (e.g., packets P1 and P2) need to be sent to the user device 226 in the downlink traffic direction. Further, in this example, the AP 202 is designated as the multiband proxy device. In that case, the common MAC layer (CMAC) of the AP 202 may include a multiband sequence number assignment function, a buffering function, and a traffic steering function in a buffering/reordering function. The packets 201 may arrive at the CMAC and each of the packets (e.g., packets P1 and P2) may be assigned a specific multiband sequence number. For example, P1 may be assigned a multiband sequence number of 1, and P2 may be assigned a multiband sequence number of 2. It should be understood that although only two packets are shown in the packets, there may be multiple packets that will also be each assigned a multiband sequence number in the CMAC of the AP 202.

At the traffic steering function of the AP talked to, decisions are made to perform packet flow control. Once the packets 201 arrive and are stored in the buffer, the traffic steering function determines where to send packets P1 and P2. The traffic steering device needs to know the network conditions associated with AP 202 and AP 204 before it makes the determination to send the packets 201. For example, the traffic steering function may determine that one interface on a specific AP is capable of handling more packets than another interface on the other AP. In effect, the traffic steering function may load balance the allocation of the packets to be transmitted on the interfaces. One or more factors may impact how the traffic steering function selects a certain number of packets to be transmitted on a first interface and another number of packets to be transmitted on a second interface. For example, some of these factors may include throughput determination or latency determination on the interfaces. This information may be provided by the APs to the multiband proxy device. In the case where the multiband proxy device is within one of the APs, the throughput determination and latency determination may be provided by the dedicated MAC layer to the common MAC layer, where the traffic steering resides. Continuing with the example of FIG. 2B, the traffic steering function on AP 202 may have determined that the AP 202 and the AP 204 have similar throughput and latency. For that reason, he traffic steering function may have decided to split the packets 50-50 between AP 202 and AP 204. Consequently, packets P1 may be sent from the common MAC layer of AP 202 to the user device 226 through the PHY layer. Similarly, the traffic steering function may have determined to send the packet P2 through the air interface 214 to the AP 204 through the air interface 216. The AP 204 may process the packet P2 and send it to the user device 226. At the user device 226 packets P1 and P2 may be received at different interfaces on the user device 226. For example, packet P1 may be received at an air interface compatible with the AP 202 (e.g., 5 GHz operation) and packet P2 may be received at an air interface compatible with the AP 204 (e.g., 6 GHz operation). The user device 226 may then aggregate these packets in order to reorder them in the same order they were transmitted (e.g., P1, followed by P2) as was intended in the packets 201.

It is understood that the above descriptions are for purposes of illustration and are not meant to be limiting.

FIG. 2C depicts an illustrative schematic diagram for a multiband aggregation flow control system, in accordance with one or more example embodiments of the present disclosure.

Referring to FIG. 2C, there is shown a user device 226 communicating with two APs (e.g., AP 202 and the AP 204). For example, the user device 226 may be accessing a web page on the internet and the AP 202 and the AP 204 may be servicing the user device 226 to complete it request to access the web page. In essence, the AP 202 and the AP 204 are both collaborating to service the user device 226. The AP 202 and the AP 204 may be managed by a control device 230. However, the control device 230 may not be necessary. In some embodiments, the AP 202 and the AP 204 may designate one of them to be a device capable of managing traffic between them and the user device 226 instead of using a control device 230.

In this example, the user device 226 may be transmitting packets P1 and P2. The user device 226 may send packet P1 through an interface included in the user device 226, wherein the interface is compatible with an interface on the AP 202. Similarly, user device 226 may send packet P2 through an interface included in the user device 226, wherein the interface is compatible with an interface on the AP 204. Although not shown, the user device 226 may have performed traffic steering internally by acting as a multiband proxy client to determine where to send packets P1 and P2, and it may have assigned multiband sequence numbers to these packets before sending them out.

In this example, the AP 202 is designated as a multiband proxy device, such that the AP 202 is responsible in its common MAC layer (CMAC) for performing buffering and reordering using the buffering/reordering function 212.

When packet P1 is received at the PHY layer of the AP 202, packet P1 is then transferred from the PHY layer to the dedicated MAC layer of the AP 202. Then the dedicated MAC layer of AP 202 may transfer packet P1 to the common MAC layer of the AP 202. Similarly, when packet P2 is received at the PHY layer of the AP 204, packet P2 is transferred to the dedicated MAC of the AP 204, which then transfers it to the common MAC layer of the AP 204. Subsequently, packet P2 may be transmitted through the air interface 216 towards the interface 214 on the AP 202. When packets P1 and P2 are received at the common MAC layer of the AP 202, packets P1 and P2 are, buffered and then reordered based on the multiband sequence number assignment performed at the user device 226. Subsequently, the packets P1 and P2 may be sent to upper layers to be sent to the Internet.

It is understood that the above descriptions are for purposes of illustration and are not meant to be limiting.

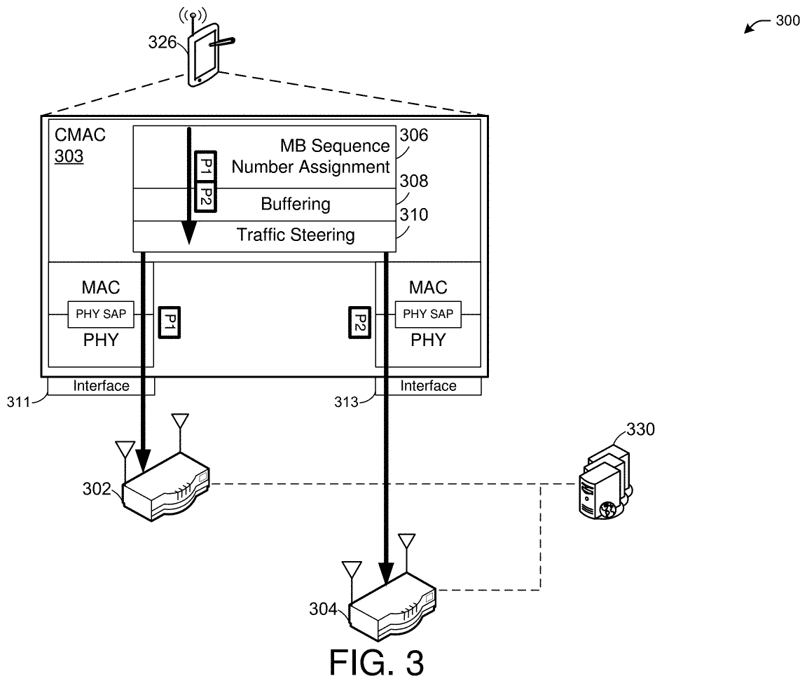

FIG. 3 depicts an illustrative schematic diagram 300 for multiband aggregation flow control system, in accordance with one or more example embodiments of the present disclosure.

Referring to FIG. 3, there is shown a user device 326 that is in communication with a first AP (e.g., AP 302) and the second AP (e.g., AP 304). It should be understood that although only two APs are shown in communication with the user device 326, any number of APs may be used. It should be understood also that a control device (e.g., control device 330) may be used to manage traffic between the AP 302, the AP 304, and/or the user device 326. For example, the user device 326 may be accessing a web page on the internet, and the AP 302 and the AP 304 may be servicing the user device 326 to complete its request to access the web page. In essence, the AP 302 and the AP 304 are both collaborating to service the user device 326.

In one embodiment, the user device 326 may be referred to as the client, in this example. The user device 326 may have one or more frequency band interfaces (e.g., interfaces 311 and 313) that allow the user device 326 to communicate on various frequency bands that may be supported by various APs. For example, if the AP 302 is a 5 GHz AP and the AP 304 is a 6 GHz AP, the user device 326 may use interface 311 to communicate with the AP 302 and interface 313 to communicate with the AP 304. It should be understood that although two interfaces are depicted, any number of interfaces may be included in the user device 326.

In one embodiment, a multiband aggregation flow control system may define how to perform flow control (traffic steering decisions) in a multiband proxy device for downlink traffic and in the multiband proxy client for uplink traffic. This flow control may consist of deciding how the traffic coming from the upper layers will be split into two or more data flows, each of them being forwarded to a specific air interface (e.g., interfaces 311 and 313). For instance, a data flow may be decided to be split with a 75%-25% ratio on interface 311 towards the AP 302 and interface 313 towards the AP 304. Note that before the packets may be split by the flow control function, the packets may be assigned a multiband sequence number, such that the peer multiband entity may perform reordering based on the multiband sequence number. This flow control function may have a strong impact on multiband aggregation performance

In one embodiment, a multiband aggregation flow control system may perform flow control with the objectives to lead to flow control decisions that are in close relation to all air interface (frequency band) throughput and latency metrics, and to enable lossless transmission of traffic between bands. It should be understood that lossless transmission means that the multiband proxy device is aware of which packet has failed to be received by an AP or a user device. A multiband sequence number is used, such that the receiving device is able to determine, after aggregating all the received packets whether a packet is missing. For example, if a multiband proxy device wants to send 100 packets to an STA, 50 packets are sent to a first AP and 50 packets are sent to a second AP. If there is a loss, some of the packets may not be received by the STA. When the multiband proxy device determines which packet having a specific sequence number failed, the multiband proxy device may be able to retransmit the specific packet. It should be understood that the multiband proxy device may be a standalone device, may reside on an AP, or may reside on a control device that controls one or more APs.

For simplicity, an example of downlink implementation of the multiband aggregation flow control system may be provided; however, this is also applicable to an uplink implementation as well.

In one embodiment, the packets P1 and P2, which arrive from the upper layers in the multiband proxy, may be assigned a multiband sequence number (this can be a specific multiband sequence number or the existing 802.11 sequence number), where the assignment may be done by the multiband sequence number assignment function 306. The packets P1 and P2 are then buffered using the buffering function 308 in the multiband proxy, before being directed to a specific AP (band) through the multiband traffic steering function 310 (multiband flow control). In this example, the traffic steering function 310 may have determined that packet P1 is to be sent to the AP 302 and packet P2 is to be sent to the AP 304.

It is understood that the above descriptions are for purposes of illustration and are not meant to be limiting.

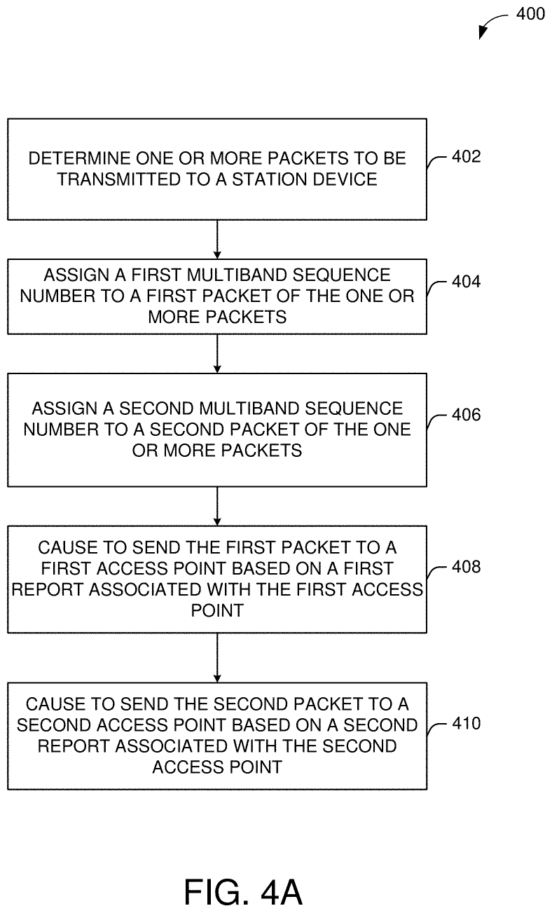

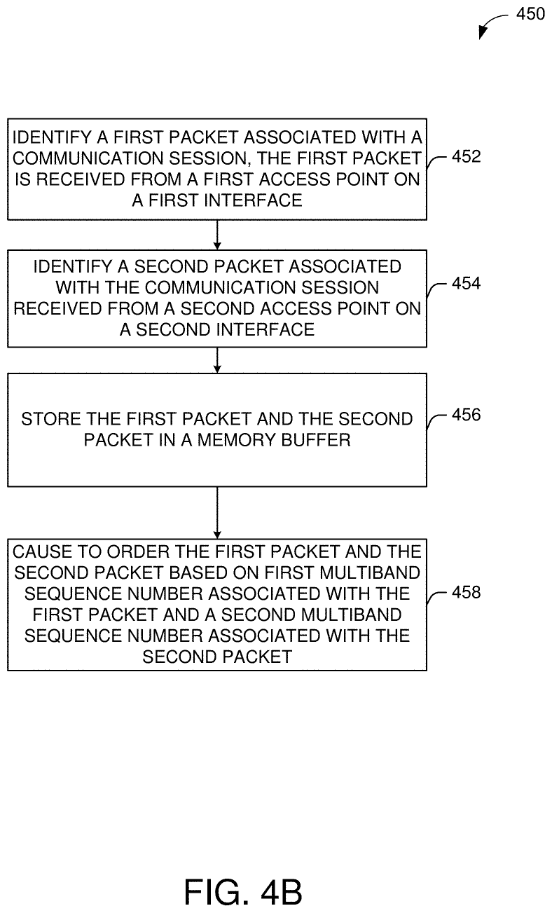

FIG. 4A illustrates a flow diagram of an illustrative process 400 for an illustrative multiband aggregation flow control system, in accordance with one or more example embodiments of the present disclosure.

At block 402, a device (e.g., the user device(s) 120 and/or the AP(s) 102 of FIG. 1) may determine one or more packets to be transmitted to a station device. The device is a multiband proxy device having one or more interfaces associated with one or more frequency bands. The multiband proxy may be a proxy device in the network that receives and aggregates packets coming in the downlink or the uplink traffic directions. For example in the downlink scenario, the packets may be coming from the upper layers (or the internet), where the multiband proxy makes decisions on whether to forward the received packets to a first AP or a second AP, where the packets would then be transmitted to a user device. The APs may be controlled by a controller device in order to effectuate collaboration between the APs. Some APs may support different frequency bands (e.g., 2.4 GHz, 5 GHz, 6 GHz, etc.). For example, in a deployment scenario a main AP may cover a large area with long range (e.g., 2.4 GHz, 5 GHz, 6 GHz, etc.) and one or more other APs may cover a small area with short range (e.g., 60 GHz, etc.) but more capacity and throughput.

At block 404, the device may assign a first multiband sequence number to a first packet of the one or more packets. As the packets arrive at the multiband proxy, they are stored in a buffer, where each packet will be assigned a sequence number. The packets that have been assigned multiband sequence numbers may then be transmitted to the first AP or the second AP.

The device that is performing the function of a multiband proxy device (e.g., an AP) may have its MAC layer split into two parts. The two parts may be an common MAC layer and a dedicated MAC layer. Consequently, the common MAC layer may be on a different device or on the same device. For example, the common MAC layer of an AP may be located in a multiband proxy device, while the dedicated MAC layer of the AP may continue to be on the AP. The common MAC layer and the dedicated MAC layer may be collocated. In the case where the common MAC layer and the dedicated MAC layer are collocated, the common MAC layer would forward the packets as they come to the dedicated MAC layer when the data is traveling in the downlink direction, while the dedicated MAC layer would forward the packets as they come to the common MAC layer when the data is traveling in the uplink direction. The common MAC layer would be responsible for multiband sequence number assignment, buffering, packet reordering, and traffic steering. The dedicated MAC layer would be responsible for transmitting packets received from the common MAC layer (in the downlink direction) to the PHY layer for transmission to the user device.

At block 406, the device may assign a second multiband sequence number to a second packet of the one or more packets.

At block 408, the device may cause to send the first packet to a first access point based on a first report associated with the first access point. For example, the first AP may send information to the multiband proxy device associated with performance data while communicating with a user device. For example, a first feedback mechanism solution may rely on feeding back from the first AP to the multiband proxy device throughput and latency estimates of the link between the user device and the first AP. Based on this information, the multiband proxy may compare the metrics from all bands and use these to perform multiband flow control. This, however, does not enable lossless transitions. A second solution may rely on feeding back a report to the multiband proxy, every time a packet or a group of packets has been successfully delivered to the user device. This report may include the multiband sequence numbers of the packets transmitted (or the first and last sequence number of a group of packets), the time at which they were delivered and possibly other information. Based on that information, the multiband proxy may derive per-band throughput and latency metrics to guide multiband flow control decisions. In addition, the multiband proxy can free up memory by removing from its buffers all the packets that have been transmitted. The remaining packets (for which the multiband proxy did not receive a report that they were successfully transmitted) may then be steered to another band/air interface/AP. This re-steering decision may be taken for instance after a specific timeout for each packet or group of packets. This timeout allows for lossless transitions of traffic between bands. The multiband proxy device may decide to send some packets on a first interface and other packets on another interface based on the feedback mechanism. For example, in this example, a first packet may be sent to the first AP and the second packet may be sent to the second AP for delivery to the user device.

At block 410, the device may cause to send the second packet to a second access point based on a second report associated with the second access point.

It is understood that the above descriptions are for purposes of illustration and are not meant to be limiting.

FIG. 4B illustrates a flow diagram of an illustrative process 450 for a multiband aggregation flow control system, in accordance with one or more example embodiments of the present disclosure.

At block 452, a device (e.g., the user device(s) 120 and/or the AP 102 of FIG. 1) may identify a first packet associated with a communication session, where the first packet is received from a first access point on a first interface. For example, a user device may be communicating with a first AP and a second AP in one communication session (e.g., a video streaming session). For example, the user device may be accessing a web page on the internet and the first AP and the second AP may be servicing the user device to complete its request to access the web page. The first AP and the second AP may be managed by a control device. However, the control device may not be necessary. In some embodiments, the first AP and the second AP may designate one of them to be a device capable of managing traffic between them and the user device instead of using a control device. Packets may be sent from the first AP and the second AP two the user device in the downlink traffic direction.

The user device will contain two or more interfaces associated with two or more frequency bands. For example, the user device may have one interface to communicate on 5 GHz and another interface to communicate on 6 GHz. The two or more interfaces would work together in order to aggregate all packets received on the two or more interfaces associated with the two or more frequency bands in the downlink direction, where the packets are received from the first AP in the second AP. In the reverse direction (e.g., uplink direction), the user device would split the packets that are generated for the uplink transmission to be transmitted on the two or more interfaces. For example, a portion of the packets may be sent on a first frequency band (e.g., 2.4 GHz, 5 GHz, 6 GHz, 60 GHz, etc.) and another portion of the packets may be sent on a second frequency band (e.g., 2.4 GHz, 5 GHz, 6 GHz, 60 GHz, etc.).

At block 454, the device may identify a second packet associated with the communication session received from a second access point on a second interface. The user device may receive the first packet from the first AP and the second packet from the second AP. It should be understood that the first AP and the second AP may be operating on different bands (e.g., 2.4 GHz, 5 GHz, 6 GHz, 60 GHz, etc.). Typically a user device or an STA is only capable of maintaining one session at a time with an AP.

At block 456, the device may store the first packet and the second packet in a memory buffer. When the user device receives the packets, it has to reorder them but before reordering, the user device may store the received packets from the first AP and the second AP in memory. The packets may be stored in any memory type device for later retrieval.

At block 458, the device may cause to order the first packet and the second packet based on a first multiband sequence number associated with the first packet and a second multiband sequence number associated with the second packet. Ordering of packets means that packets are placed in a sequence based on the sequence number. For example, a first packet with a first sequence number comes before a second packet with a second sequence number, where the first sequence number is less than the second sequence number. A multiband sequence number may be assigned to each of the packets such that the user device receiving these packets from separate interfaces is capable of reorganizing or reordering the packets in the original order. It should be understood that the multiband sequence number is not necessarily associated with the frequency band interface where the packet was sent from or to. Packets may be received and stored in a buffer until all the necessary packets are received and buffered. Then the packets are reordered based on the multiband sequence number for correct decoding.

It is understood that the above descriptions are for purposes of illustration and are not meant to be limiting.

FIG. 5 shows a functional diagram of an exemplary communication station 500 in accordance with some embodiments. In one embodiment, FIG. 5 illustrates a functional block diagram of a communication station that may be suitable for use as an AP 102 (FIG. 1) or user device 120 (FIG. 1) in accordance with some embodiments. The communication station 500 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 500 may include communications circuitry 502 and a transceiver 510 for transmitting and receiving signals to and from other communication stations using one or more antennas 501. The communications circuitry 502 may include circuitry that can operate the physical layer (PHY) communications and/or media access control (MAC) communications for controlling access to the wireless medium, and/or any other communications layers for transmitting and receiving signals. The communication station 500 may also include processing circuitry 506 and memory 508 arranged to perform the operations described herein. In some embodiments, the communications circuitry 502 and the processing circuitry 506 may be configured to perform operations detailed in FIGS. 1-4.

In accordance with some embodiments, the communications circuitry 502 may be arranged to contend for a wireless medium and configure frames or packets for communicating over the wireless medium. The communications circuitry 502 may be arranged to transmit and receive signals. The communications circuitry 502 may also include circuitry for modulation/demodulation, upconversion/downconversion, filtering, amplification, etc. In some embodiments, the processing circuitry 506 of the communication station 500 may include one or more processors. In other embodiments, two or more antennas 501 may be coupled to the communications circuitry 502 arranged for sending and receiving signals. The memory 508 may store information for configuring the processing circuitry 506 to perform operations for configuring and transmitting message frames and performing the various operations described herein. The memory 508 may include any type of memory, including non-transitory memory, for storing information in a form readable by a machine (e.g., a computer). For example, the memory 508 may include a computer-readable storage device, read-only memory (ROM), random-access memory (RAM), magnetic disk storage media, optical storage media, flash-memory devices and other storage devices and media.

In some embodiments, the communication station 500 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 500 may include one or more antennas 501. The antennas 501 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 500 may include one or more of a keyboard, a display, a non-volatile memory port, multiple antennas, a graphics processor, an application processor, speakers, and other mobile device elements. The display may be an LCD screen including a touch screen.

Although the communication station 500 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 500 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 500 may include one or more processors and may be configured with instructions stored on a computer-readable storage device memory.

FIG. 6 illustrates a block diagram of an example of a machine 600 or system upon which any one or more of the techniques (e.g., methodologies) discussed herein may be performed. In other embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environments. The machine 600 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a power management device 632, a graphics display device 610, an alphanumeric input device 612 (e.g., a keyboard), and a user interface (UI) navigation device 614 (e.g., a mouse). In an example, the graphics display device 610, alphanumeric input device 612, and UI navigation device 614 may be a touch screen display. The machine 600 may additionally include a storage device (i.e., drive unit) 616, a signal generation device 618 (e.g., a speaker), a multiband aggregation flow control device 619, a network interface device/transceiver 620 coupled to antenna(s) 630, and one or more sensors 628, such as a global positioning system (GPS) sensor, a compass, an accelerometer, or other sensor. The machine 600 may include an output controller 634, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within the static memory 606, or within the hardware processor 602 during execution thereof by the machine 600. In an example, one or any combination of the hardware processor 602, the main memory 604, the static memory 606, or the storage device 616 may constitute machine-readable media.

The multiband aggregation flow control device 619 may carry out or perform any of the operations and processes (e.g., the processes 400 and 450) described and shown above. For example, the multiband aggregation flow control device 619 may be configured to provide a means by which significantly higher throughput or higher reliability may be achieved if two STAs or a STA and the AP support simultaneous multiband operation.

The multiband aggregation flow control device 619 may include one or more APs that may be controlled by a controller device in order to effectuate collaboration between the APs. In this scenario, some APs may support different frequency bands (e.g., 2.4 GHz, 5 GHz, 6 GHz, etc.). For example, in a deployment scenario, a main AP (also referred to as an anchor AP) may cover a large area with long range (e.g., 2.4 GHz, 5 GHz, 6 GHz, etc.) and one or more other APs (also referred to as booster APs) may cover a small area with short range (e.g., 60 GHz, etc.) but with more capacity and throughput. Within the coverage area of the anchor AP, the coverage area may also cover the one or more booster APs.

The multiband aggregation flow control device 619 may define a multiband proxy. The multiband proxy may be a proxy device in the network that receives and aggregates packets coming in the downlink or the uplink traffic directions. For example in the downlink scenario, the packets may be coming from the upper layers (or the internet), where the multiband proxy makes decisions on whether to forward the received packets to a first AP or a second AP, where the packets would then be transmitted to an STA.

The multiband aggregation flow control device 619 may facilitate that as the packets arrive at the multiband proxy, they are stored in a buffer, where each packet will be assigned a sequence number. The packets that have been assigned multiband sequence numbers may then be transmitted to the first AP or the second AP.

The multiband aggregation flow control device 619 may define a link aggregation at the media access control (MAC) layer (or higher layers), by establishing multiple links between two peer STAs on different bands with different air interfaces, which operate independently from the each other. These multiple links may be aggregated, for instance, in a multiband common MAC defined in each of the peer STAs. Fast session transfer (FST) defined in 802.11ad may serve as a baseline framework for this link aggregation. The aggregation may enable a traffic flow to be distributed on multiple bands/air interfaces in order to sum the throughputs from the different air interfaces. The aggregation may also direct a specific traffic type on the best air interface (highest throughput interface, most reliable interface, or lower latency interface, etc.). This aggregation may be done transparently to the upper layers, in which case a single MAC service access point (SAP) is exposed to the upper layers.

The multiband aggregation flow control device 619 may determine to split the MAC layer of a device (e.g., an AP) into two parts. The two parts may be an common MAC layer and a dedicated MAC layer. Consequently, the common MAC layer may be on a different device or on the same device. For example, the common MAC layer of an AP may be located in a multiband proxy device, while the dedicated MAC layer of the AP may continue to be on the AP. The common MAC layer and the dedicated MAC layer may be collocated. In the case where the common MAC layer and the dedicated MAC layer are collocated, the common MAC layer would forward the packets as they come to the dedicated MAC layer when the data is traveling in the downlink direction, while the dedicated MAC layer would forward the packets as they come to the common MAC layer when the data is traveling in the uplink direction. The common MAC layer would be responsible for multiband sequence number assignment, buffering, packet reordering, and traffic steering. The dedicated MAC layer would be responsible for transmitting packets received from the common MAC layer (in the downlink direction) to the PHY layer for transmission to the STA.

The multiband aggregation flow control device 619 may perform flow control using a traffic steering function or the flow control function included in the common MAC layer. The traffic steering function on the multiband proxy may determine how to split the traffic between the interfaces. Once the packets arrive and are stored in the buffer, the traffic steering device determines whether to send a first portion of packets to a first AP and another portion of packets to a second AP. The traffic steering device needs to know the network conditions associated with the first AP and the second AP before it makes the determination to send the packets. For example, the traffic steering function may determine that one interface is capable of handling more packets than another interface. In effect, the traffic steering function may load balance the allocation of the packets to be transmitted on the interfaces. One or more factors may impact how the traffic steering function selects a certain number of packets to be transmitted on a first interface and another number of packets to be transmitted on a second interface. For example, some of these factors may include throughput determination or latency determination on the interfaces. This information may be provided by the APs to the multiband proxy device. In case the multiband proxy device is within one of the APs, the throughput determination and latency determination may be provided by the dedicated MAC layer to the common MAC layer, where the traffic steering resides. It should be understood that throughput is the rate of successful packet delivery over a communication channel The latency may be determined by measuring a time delay from one networked point to another. Latency is measured by sending a packet that is returned to the transmitting device, where the round-trip time is considered the latency.

The multiband aggregation flow control device 619 may be implemented on an STA such that the STA will contain two or more interfaces associated with two or more frequency bands. For example, an STA may have one interface to communicate on 5 GHz and another interface to communicate on 6 GHz. The two or more interfaces would work together in order to aggregate all packets received on the two or more interfaces associated with the two or more frequency bands in the downlink direction, where the packets are received from one or more APs. In the reverse direction (e.g., uplink direction), the STA would split the packets that are generated for the uplink transmission to be transmitted on the two or more interfaces. For example, a portion of the packets may be sent on a first frequency band (e.g., 2.4 GHz, 5 GHz, 6 GHz, 60 GHz, etc.) and another portion of the packets may be sent on a second frequency band (e.g., 2.4 GHz, 5 GHz, 6 GHz, 60 GHz, etc.). A multiband sequence number may be assigned to each of the packets such that the devices receiving these packets from separate interfaces are capable of reorganizing or reordering the packets in the original order. It should be understood that the multiband sequence number is not necessarily associated with the frequency band interface where the packet was sent from or to. Packets may be received and stored in a buffer until all the necessary packets are received and buffered. Then the packets are reordered based on the multiband sequence number for correct decoding.

The multiband aggregation flow control device 619 may facilitate that when an STA is connected to, for example, a first AP (e.g., an anchor or booster AP) and a second AP (e.g., an anchor or booster AP), the STA may be able to aggregate the throughput, such that the STA is capable of sending some traffic on a first frequency band through the first AP and sending some traffic on, a second frequency band through the second AP. This is true in the uplink direction (e.g., from the STA to the APs) and in the downlink direction (e.g., from the APs to the STA). That is, in the downlink and the uplink, the traffic will be split between the two air interfaces (e.g., the first frequency band and the second frequency band). For example, if the throughput is 100 megabits per second on the first AP and 200 megabits per second on the second AP, a 300 megabits per second aggregated throughput may be achieved.

It is understood that the above are only a subset of what the multiband aggregation flow control device 619 may be configured to perform and that other functions included throughout this disclosure may also be performed by the multiband aggregation flow control device 619.

While the machine-readable medium 622 is illustrated as a single medium, the term “machine-readable medium” may include a single medium or multiple media (e.g., a centralized or distributed database, and/or associated caches and servers) configured to store the one or more instructions 624.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 600 and that cause the machine 600 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device/transceiver 620 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 620 may include one or more physical jacks (e.g., Ethernet, coaxial, or phone jacks) or one or more antennas to connect to the communications network 626. In an example, the network interface device/transceiver 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 600 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner

The term “access point” (AP) as used herein may be a fixed station. An access point may also be referred to as an access node, a base station, an evolved node B (eNodeB), an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Example 1 may include a device comprising: memory and processing circuitry, configured to: determine one or more packets to be transmitted to a station device; assign a first multiband sequence number to a first packet of the one or more packets; assign a second multiband sequence number to a second packet of the one or more packets; cause to send the first packet to a first access point based on a first report associated with the first access point;

and cause to send the second packet to a second access point based on a second report associated with the second access point.

Example 2 may include the device of example 1 and/or some other example herein, wherein the memory and the processing circuitry are further configured to perform traffic steering of the one or more packets based on the first report and the second report.

Example 3 may include the device of example 1 and/or some other example herein, wherein the first report comprises data associated with at least one of throughput information, latency information, or readability information.

Example 4 may include the device of example 3 and/or some other example herein, wherein the throughput information may be associated with a successful packet transmission between the first access point and the station device.

Example 5 may include the device of example 3 and/or some other example herein, wherein the latency information may be associated with an elapsed time to exchange packets between the first access point and the station device.

Example 6 may include the device of example 1 and/or some other example herein, wherein the first packet may be sent through a first interface on the device.

Example 7 may include the device of example 1 and/or some other example herein, wherein the second packet may be sent through a second interface on the device.

Example 8 may include the device of example 6 and/or some other example herein, wherein the first interface may be associated with 2.4 gigahertz or 5 gigahertz.

Example 9 may include the device of example 7 and/or some other example herein, wherein the second interface may be associated with 6 gigahertz or 60 gigahertz.

Example 10 may include the device of example 1 and/or some other example herein, wherein the first interface and the second interface are in the same frequency band, wherein the first interface may be an upper portion of the frequency band and the second interface may be a lower portion of the frequency band.

Example 11 may include the device of example 1 and/or some other example herein, wherein the device may be a multiband proxy device having one or more interfaces associated with one or more frequency bands.

Example 12 may include the device of example 1 and/or some other example herein, further comprising a transceiver configured to transmit and receive wireless signals.

Example 13 may include the device of example 12 and/or some other example herein, further comprising one or more antennas coupled to the transceiver.

Example 14 may include a non-transitory computer-readable medium storing computer-executable instructions which when executed by one or more processors result in performing operations comprising: identifying a first packet associated with a communication session, wherein the first packet may be received from a first access point on a first interface; identifying a second packet associated with the communication session received from a second access point on a second interface; storing the first packet and the second packet in a memory buffer; and causing to order the first packet and the second packet based on a first multiband sequence number associated with the first packet and a second multiband sequence number associated with the second packet.

Example 15 may include the non-transitory computer-readable medium of example 14 and/or some other example herein, wherein the first multiband sequence number and the second multiband sequence number are assigned by the first access point.

Example 16 may include the non-transitory computer-readable medium of example 14 and/or some other example herein, wherein the first sequence number in the second multiband sequence number are assigned in an upper medium access control (MAC) layer of the first access point.

Example 17 may include the non-transitory computer-readable medium of example 14 and/or some other example herein, wherein a medium access control (MAC) layer of the first access point may be divided into a common MAC layer and a dedicated MAC layer.

Example 18 may include the non-transitory computer-readable medium of example 14 and/or some other example herein, wherein the first packet may be received on a first interface and the second packet may be received on a second interface.

Example 19 may include the non-transitory computer-readable medium of example 14 and/or some other example herein, wherein the first interface may be associated with 2.4 gigahertz or 5 gigahertz.

Example 20 may include the non-transitory computer-readable medium of example 14 and/or some other example herein, wherein the second interface may be associated with 6 gigahertz or 60 gigahertz.

Example 21 may include a method comprising: determining, by one or more processors, one or more packets to be transmitted to a station device; assigning a first multiband sequence number to a first packet of the one or more packets; assigning a second multiband sequence number to a second packet of the one or more packets; causing to send the first packet to a first access point based on a first report associated with the first access point; and causing to send the second packet to a second access point based on a second report associated with the second access point.

Example 22 may include the method of example 21 and/or some other example herein, further comprising performing traffic steering of the one or more packets based on the first report and the second report.

Example 23 may include the method of example 21 and/or some other example herein, wherein the first report comprises data associated with at least one of throughput information, latency information, or readability information.

Example 24 may include the method of example 23 and/or some other example herein, wherein the throughput information may be associated with a successful packet transmission between the first access point and the station device.

Example 25 may include the method of example 23 and/or some other example herein, wherein the latency information may be associated with an elapsed time to exchange packets between the first access point and the station device.

Example 26 may include the method of example 21 and/or some other example herein, wherein the first packet may be sent through a first interface on the device.

Example 27 may include the method of example 21 and/or some other example herein, wherein the second packet may be sent through a second interface on the device.

Example 28 may include the method of example 26 and/or some other example herein, wherein the first interface may be associated with 2.4 gigahertz or 5 gigahertz.

Example 29 may include the method of example 27 and/or some other example herein, wherein the second interface may be associated with 6 gigahertz or 60 gigahertz.

Example 30 may include the method of example 21 and/or some other example herein, wherein the first interface and the second interface are in the same frequency band, wherein the first interface may be an upper portion of the frequency band and the second interface may be a lower portion of the frequency band.

Example 31 may include the method of example 21 and/or some other example herein, wherein the device may be a multiband proxy device having one or more interfaces associated with one or more frequency bands.

Example 32 may include an apparatus comprising means for performing a method as claimed in any one of examples 21-31,

Example 33 may include a system comprising at least one memory device having programmed instruction that, in response to execution cause at least one processor to perform the method of any one of examples 21-31.

Example 34 may include a machine readable medium including code, when executed, to cause a machine to perform the method of any one of examples 21-31.

Example 35 may include an apparatus comprising means for determining, by one or more processors, one or more packets to be transmitted to a station device; means for assigning a first multiband sequence number to a first packet of the one or more packets; means for assigning a second multiband sequence number to a second packet of the one or more packets; means for causing to send the first packet to a first access point based on a first report associated with the first access point; and means for causing to send the second packet to a second access point based on a second report associated with the second access point.

Example 36 may include the apparatus of example 35 and/or some other example herein, further comprising performing traffic steering of the one or more packets based on the first report and the second report.

Example 37 may include the apparatus of example 35 and/or some other example herein, wherein the first report comprises data associated with at least one of throughput information, latency information, or readability information.

Example 38 may include the apparatus of example 37 and/or some other example herein, wherein the throughput information may be associated with a successful packet transmission between the first access point and the station device.

Example 39 may include the apparatus of example 37 and/or some other example herein, wherein the latency information may be associated with an elapsed time to exchange packets between the first access point and the station device.

Example 40 may include the apparatus of example 35 and/or some other example herein, wherein the first packet may be sent through a first interface on the device.

Example 41 may include the apparatus of example 35 and/or some other example herein, wherein the second packet may be sent through a second interface on the device.

Example 42 may include the apparatus of example 35 and/or some other example herein, wherein the first interface may be associated with 2.4 gigahertz or 5 gigahertz.

Example 43 may include the apparatus of example 41 and/or some other example herein, wherein the second interface may be associated with 6 gigahertz or 60 gigahertz.

Example 44 may include the apparatus of example 35 and/or some other example herein, wherein the first interface and the second interface are in the same frequency band, wherein the first interface may be an upper portion of the frequency band and the second interface may be a lower portion of the frequency band.

Example 45 may include the apparatus of example 35 and/or some other example herein, wherein the device may be a multiband proxy device having one or more interfaces associated with one or more frequency bands.

Example 46 may include a device comprising: memory and processing circuitry, configured to: identify a first packet associated with a communication session, wherein the first packet may be received from a first access point on a first interface; identify a second packet associated with the communication session received from a second access point on a second interface; store the first packet and the second packet in a memory buffer; and cause to order the first packet and the second packet based on a first multiband sequence number associated with the first packet and a second multiband sequence number associated with the second packet.

Example 47 may include the device of example 46 and/or some other example herein, wherein the first multiband sequence number and the second multiband sequence number are assigned by the first access point.

Example 48 may include the device of example 46 and/or some other example herein, wherein the first sequence number in the second multiband sequence number are assigned in an upper medium access control (MAC) layer of the first access point.

Example 49 may include the device of example 46 and/or some other example herein, wherein a medium access control (MAC) layer of the first access point may be divided into an common MAC layer and a dedicated MAC layer.

Example 50 may include the device of example 46 and/or some other example herein, wherein the first packet may be received on a first interface and the second packet may be received on a second interface.

Example 51 may include the device of example 46 and/or some other example herein, wherein the first interface may be associated with 2.4 gigahertz or 5 gigahertz.

Example 52 may include the device of example 46 and/or some other example herein, wherein the second interface may be associated with 6 gigahertz or 60 gigahertz.

Example 53 may include the device of example 46 and/or some other example herein, further comprising a transceiver configured to transmit and receive wireless signals.

Example 54 may include the device of example 53 and/or some other example herein, further comprising one or more antennas coupled to the transceiver.

Example 55 may include a method comprising: identifying a first packet associated with a communication session, wherein the first packet may be received from a first access point on a first interface; identifying a second packet associated with the communication session received from a second access point on a second interface; storing the first packet and the second packet in a memory buffer; and causing to order the first packet and the second packet based on a first multiband sequence number associated with the first packet and a second multiband sequence number associated with the second packet.

Example 56 may include the method of example 55 and/or some other example herein, wherein the first multiband sequence number and the second multiband sequence number are assigned by the first access point.

Example 57 may include the method of example 55 and/or some other example herein, wherein the first sequence number in the second multiband sequence number are assigned in an upper medium access control (MAC) layer of the first access point.

Example 58 may include the method of example 55 and/or some other example herein, wherein a medium access control (MAC) layer of the first access point may be divided into a common MAC layer and a dedicated MAC layer.

Example 59 may include the method of example 55 and/or some other example herein, wherein the first packet may be received on a first interface and the second packet may be received on a second interface.

Example 60 may include the method of example 55 and/or some other example herein, wherein the first interface may be associated with 2.4 gigahertz or 5 gigahertz.

Example 61 may include the method of example 55 and/or some other example herein, wherein the second interface may be associated with 6 gigahertz or 60 gigahertz.

Example 62 may include an apparatus comprising means for performing a method as claimed in any one of examples 55-61.

Example 63 may include a system comprising at least one memory device having programmed instruction that, in response to execution cause at least one processor to perform the method of any one of examples 55-61.

Example 64 may include a machine readable medium including code, when executed, to cause a machine to perform the method of any one of examples 55-61.

Example 65 may include an apparatus comprising means for identifying a first packet associated with a communication session, wherein the first packet may be received from a first access point on a first interface; means for identifying a second packet associated with the communication session received from a second access point on a second interface; means for storing the first packet and the second packet in a memory buffer; and means for causing to order the first packet and the second packet based on a first multiband sequence number associated with the first packet and a second multiband sequence number associated with the second packet.

Example 66 may include the apparatus of example 65 and/or some other example herein, wherein the first multiband sequence number and the second multiband sequence number are assigned by the first access point.

Example 67 may include the apparatus of example 65 and/or some other example herein, wherein the first sequence number in the second multiband sequence number are assigned in an upper medium access control (MAC) layer of the first access point.

Example 68 may include the apparatus of example 65 and/or some other example herein, wherein a medium access control (MAC) layer of the first access point may be divided into a common MAC layer and a dedicated MAC layer.

Example 69 may include the apparatus of example 65 and/or some other example herein, wherein the first packet may be received on a first interface and the second packet may be received on a second interface.

Example 70 may include the apparatus of example 65 and/or some other example herein, wherein the first interface may be associated with 2.4 gigahertz or 5 gigahertz.

Example 71 may include the apparatus of example 65 and/or some other example herein, wherein the second interface may be associated with 6 gigahertz or 60 gigahertz.

Example 72 may include an apparatus comprising means for performing a method as claimed in any of the preceding examples.

Example 73 may include a machine-readable storage including machine-readable instructions, when executed, to implement a method as claimed in any proceeding examples.

Example 74 may include a machine-readable storage including machine-readable instructions, when executed, to implement a method or realize an apparatus as claimed in any preceding example

Example 75 may include one or more non-transitory computer-readable media comprising instructions to cause an electronic device, upon execution of the instructions by one or more processors of the electronic device, to perform one or more elements of a method described in or related to any of examples 1-74, or any other method or process described herein.

Example 76 may include an apparatus comprising logic, modules, and/or circuitry to perform one or more elements of a method described in or related to any of examples 1-74, or any other method or process described herein.

Example 77 may include a method, technique, or process as described in or related to any of examples 1-74, or portions or parts thereof.

Example 78 may include an apparatus comprising: one or more processors and one or more computer readable media comprising instructions that, when executed by the one or more processors, cause the one or more processors to perform the method, techniques, or process as described in or related to any of examples 1-74, or portions thereof.

Example 79 may include a method of communicating in a wireless network as shown and described herein.

Example 80 may include a system for providing wireless communication as shown and described herein.

Example 81 may include a device for providing wireless communication as shown and described herein.

Embodiments according to the disclosure are in particular disclosed in the attached examples directed to a method, a storage medium, a device and a computer program product, wherein any feature mentioned in one example category, e.g., method, can be claimed in another example category, e.g., system, as well. The dependencies or references back in the attached examples are chosen for formal reasons only. However, any subject matter resulting from a deliberate reference back to any previous examples (in particular multiple dependencies) can be claimed as well, so that any combination of examples and the features thereof are disclosed and can be claimed regardless of the dependencies chosen in the attached examples. The subject-matter which can be claimed comprises not only the combinations of features as set out in the attached examples but also any other combination of features in the examples, wherein each feature mentioned in the examples can be combined with any other feature or combination of other features in the examples. Furthermore, any of the embodiments and features described or depicted herein can be claimed in a separate example and/or in any combination with any embodiment or feature described or depicted herein or with any of the features of the attached examples.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1.-25. (canceled)

26. A device, the device comprising: memory and processing circuitry, configured to:
determine one or more packets to be transmitted to a station device;
assign a first multiband sequence number to a first packet of the one or more packets;
assign a second multiband sequence number to a second packet of the one or more packets;
cause to send the first packet to a first access point based on a first report associated with the first access point; and
cause to send the second packet to a second access point based on a second report associated with the second access point.

27. The device of claim 26, wherein the memory and the processing circuitry are further configured to perform traffic steering of the one or more packets based on the first report and the second report.

28. The device of claim 26, wherein the first report comprises data associated with at least one of throughput information, latency information, or readability information.

29. The device of claim 28, wherein the throughput information is associated with a successful packet transmission between the first access point and the station device.

30. The device of claim 28, wherein the latency information is associated with an elapsed time to exchange packets between the first access point and the station device.

31. The device of claim 26, wherein the first packet is sent through a first interface on the device.

32. The device of claim 26, wherein the second packet is sent through a second interface on the device.

33. The device of claim 31, wherein the first interface is associated with 2.4 gigahertz or 5 gigahertz.

34. The device of claim 32, wherein the second interface is associated with 6 gigahertz or 60 gigahertz.

35. The device of claim 26, wherein the first interface and the second interface are in the same frequency band, wherein the first interface is an upper portion of the frequency band and the second interface is a lower portion of the frequency band.

36. The device of claim 26, wherein the device is a multiband proxy device having one or more interfaces associated with one or more frequency bands.

37. The device of claim 26, further comprising a transceiver configured to transmit and receive wireless signals.

38. The device of claim 37, further comprising one or more antennas coupled to the transceiver.

39. A non-transitory computer-readable medium storing computer-executable instructions which when executed by one or more processors result in performing operations comprising:
identifying a first packet associated with a communication session, wherein the first packet is received from a first access point on a first interface;
identifying a second packet associated with the communication session received from a second access point on a second interface;
storing the first packet and the second packet in a memory buffer; and
causing to order the first packet and the second packet based on a first multiband sequence number associated with the first packet and a second multiband sequence number associated with the second packet.

40. The non-transitory computer-readable medium of claim 39, wherein the first multiband sequence number and the second multiband sequence number are assigned by the first access point.

41. The non-transitory computer-readable medium of claim 39, wherein the first sequence number in the second multiband sequence number are assigned in an upper medium access control (MAC) layer of the first access point.

42. The non-transitory computer-readable medium of claim 39, wherein a medium access control (MAC) layer of the first access point is divided into an common MAC layer and a dedicated MAC layer.

43. The non-transitory computer-readable medium of claim 39, wherein the first packet is received on a first interface and the second packet is received on a second interface.

44. The non-transitory computer-readable medium of claim 39, wherein the first interface is associated with 2.4 gigahertz or 5 gigahertz.

45. A method comprising:
determining, by one or more processors, one or more packets to be transmitted to a station device;
assigning a first multiband sequence number to a first packet of the one or more packets;
assigning a second multiband sequence number to a second packet of the one or more packets;
causing to send the first packet to a first access point based on a first report associated with the first access point; and
causing to send the second packet to a second access point based on a second report associated with the second access point.
